(19) United States
(12) Patent Application Publication
(10) Pub. No.: US 2018/0052239 A1
(43) Pub. Date: Feb. 22, 2018

(54) DATA PROCESSING METHOD OF PERSONAL RADIATION DOSIMETER TO RECOGNIZE ACTIVITY OF WEARER BY USING MOTION SENSOR VALUE

(71) Applicant: FCUNWIRED CO., LTD., Seoul (KR)

(72) Inventors: Hyunsoo SEOL, Uiwang-si (KR); Geunyong YANG, Namyangju-si (KR); Seonho NA, Seoul (KR); Taewan KIM, Seoul (KR)

(21) Appl. No.: 15/679,298

(22) Filed: Aug. 17, 2017

(30) Foreign Application Priority Data
Aug. 22, 2016 (KR) 10-2016-0105998

(51) Int. Cl. G01T 1/02; G01T 7/12; G01T 3/06; G01T 3/08; H04W 4/02

(52) U.S. Cl. CPC G01T 1/026; G01T 7/125; H04W 4/02; G01T 3/08; G01T 3/06

(57) ABSTRACT

A method for recognizing whether a radiation worker normally wears a personal radiation dosimeter, recognizing a radiation dose and work behavior at a specific time point by integrally analyzing radiation measurement data of a personal radiation dosimeter and motion data of a radiation worker, and helping improvement of work behavior of a radiation worker and improvement of radioactive danger recognition on the basis of such data.

### CROSS-REFERENCE TO RELATED APPLICATION

This application claims priority to Korean Patent Application No. 10-2016-0105998, filed Aug. 22, 2016, the entire content of which is incorporated herein by reference.

### BACKGROUND OF THE INVENTION

### 1. Field of the Invention

The present invention relates to a method for recognizing activity of a wearer by using a motion sensor in a personal radiation dosimeter, and more specifically, to a data processing method of a personal radiation dosimeter to recognize whether a wearer normally wears a radiation dosimeter, to recognize work behavior of the wearer by integrally analyzing radiation measurement data and motion data of the wearer, and to recognize activity of the wearer by using a motion sensor value helpful to improvement of work behavior and improvement of radioactive danger recognition of the wearer on the basis thereof.

### 2. Description of Related Art

Radioactivity means the number of nuclear changes per unit time, and the unit thereof is Becquerel (Bq) or Curie (Ci). 1 Becquerel means that one nuclear conversion occurs every second in a substance. In radioactivity, attenuation occurs as time passes, and a half-life means the time for initial radioactivity to be reduced in half. As described above, radioactive decay occurs while radioactivity is attenuated. In this case, particles or electromagnetic energy flow emitted from atoms or atomic nucleuses are radiation. The radiation is classified into alpha-ray, beta-ray, gamma-ray, X-ray, electron-ray, proton, neutron-ray, and the like. The radiation presents various physical characteristics such as energy intensity and permeability in accordance with the type of radiation, and may have a harmful influence on a human body. Even when a human body is exposed to a same amount of radiation-absorbed dose, health risks are different in accordance with the type and energy of radiation at the time of irradiation to the human body. Accordingly, a radiation dose obtained by correcting an absorbed dose by reflecting biological effects is represented by a unit such as Sievert (Sv) or rem. 1 Sv is 100 rem. Globally, an annual average radiation exposure of general people is 2.4 mSv, and according to the causing substance, radon (55%), in-body radiation (11%), perceptual radiation (8%), spaceship (8%), and the like are referred to as natural radiation, and diagnostic X-ray (11%), therapeutic radiation (4%), consumer goods (3%), and the like are referred to as artificial radiation. When exposure to artificial radiation in addition to exposure to such natural radiation is excessive, the radiation harms the human body. Therefore, a radiation dose limit is determined and managed by law from the government such that exposure of general people does not exceed 1 mSv per year and exposure of radiation workers does not exceed 50 mSv per year. However, medical exposure is increasing, for example, exposure of one medical CT scan is 6.9 mSv exceeding an annual allowance limit. Accordingly, social risk is also increasing. In the case of the United States, in 1980, an annual individual average exposure dose was 3.6 mSv, and 0.8 mSv thereof was medical exposure. However, in 2006, an annual individual average exposure dose was increased to 6 mSv, 4.5 mSv thereof was medical exposure, and it can be seen that medical exposure had increased five times or more in 26 years.

Workers in nuclear handling institutions such as medical institutions, nuclear power plants, and nuclear research institutes have to obligatorily wear a personal radiation dosimeter by law, and are managed by the government to prevent an accident caused by radiation exposure. The personal radiation dosimeter is generally referred to as a thermo luminescent dosimeter (TLD), and measures post accumulation by the unit of several months. Since the thermo luminescent dosimeter cannot perform real-time measurement, real-time measurement dosimeters referred to as a personal radiation dosimeter (PRD) have been subsidiarily used in the industrial field, but are not spread to the industry due to factors such as a large volume, a high price, and inaccuracy of measurement.

The conventional thermo luminescent dosimeter is a badge type measurement tool which measures radiation by using a phenomenon that a thermoluminescence substance absorbs energy when receiving radiation, and emits energy in the type of light again while collected electrons break away when heat is applied. It is a personal radiation measurement tool which is enforced by law to radiation workers working in most of the world medical institutions and industrial field and is most widely used. However, the thermo luminescent dosimeter cannot perform real-time measurement. A professional measurement company collects thermo luminescent dosimeters in the period of 2 to 3 months and executes work for measurement, and only post accumulation is figured out. Accordingly, since it cannot be known when, where, and how a radiation worker is exposed, it does not help supporting safety of a worker, improving behavior and consciousness of a worker, and actively managing exposure.

Portable personal radiation dosimeters (PRD) are spreading to solve problems of the thermo luminescent dosimeters. Since it is a personal measurement device, it is a portable size, and it is possible to measure a radiation dose in real time, to display it on a display, to warn with an alarm in case of emergency or when a radiation dose equal to or more than an expected value is measured, and to help taking immediate protective action. However, the personal radiation dosimeter (PRD) is expensive, being more than thousands of dollars, and has large financial burden for all radiation workers to wear. A person can carry the personal radiation dosimeter (PRD), but the personal radiation dosimeter (PRD) is relatively large, and is not suitable to wear. There is also complicacy in management such as battery replacement. Thus, the personal radiation dosimeter (PRD) is not widely spread, and is not suitable to systemically manage and monitor an exposure dose. In addition, the personal radiation dosimeter (PRD) is not a device which has to be obligatorily worn by law, and is ignored in the field.

Since both of the thermo luminescent dosimeter (TLD) and the personal radiation dosimeter (PRD) have no communication function, the measured radiation dose cannot be transmitted to a control server. Individual exposure data cannot be accumulated due to such defects, and there is no way to find out meaningful improvement measures in exposure data. In addition, they are provided with only a radiation measurement sensor therein, so it may be possible to find out radiation dose data, but exposure data associated with behavior of a worker cannot be extracted because there is no motion sensor.

### SUMMARY OF THE INVENTION

The present invention has been made in consideration of such problems, and is to provide a data processing method of a personal radiation dosimeter which couples real-time radiation dose measurement data with motion sensor data, transmits the data to a control server by using a communication device, provides a work improvement method of a radiation worker through real-time and cumulative time radiation doses of a worker and behavior pattern analysis, and can recognize activity of a wearer by using a motion sensor value helping safety of a radiation worker.

A data processing method of a personal radiation dosimeter to recognize activity of a wearer by using a motion sensor value according to the present invention to achieve the objects described above includes steps of: detecting a value of a radiation sensor provided with a dosimeter; generating a movement value by a value of the motion sensor provided in the dosimeter; generating a shock value which is a change value of a gravity axis from the value of the motion sensor provided in the dosimeter; generating a measurement time in a clock sensor provided in the dosimeter; coupling data values of the sensors into one-packet data; transmitting the packet data to a control server through a communication device; and extracting a motion state in radiation work environment of a dosimeter wearer on the basis of the radiation sensor value and motion sensor value of the packet data.

The motion sensor may be a 3-axis accelerometer.

The data processing method of a personal radiation dosimeter may further include a step of issuing an alert when downward shock occurs in a high-level radioactive status on the basis of the shock value and the radiation sensor value.

The data processing method of a personal radiation dosimeter may further include a step of comparing an activity time with a stop time to determine whether a dosimeter is worn.

The data processing method of a personal radiation dosimeter may further include a step of determining a case where the movement value is an activity state at the time without a work history of a worker and the radiation sensor value is equal to or more than a reference value, as use by others.

The communication device may use any one of ZigBee communication, Bluetooth communication, Wi-Fi communication, and low power wide area network (LPWAN).

In addition, the present invention provides means which couples radiation detection data detected by a radiation sensor, motion data of a worker detected by a motion sensor, and measurement time data, and transmits the data to a control server by using a wired or wireless communication device, wherein the server extracts behavior of a worker, to generate methods for improving a working method and promoting safety consciousness.

Specifically, a risk range of real-time radiation measurement is classified into safety, caution, warning, and the like, and the motion data of the motion sensor is classified into stop and activity, and is interlocked with a measurement time. Particularly, real-time measurement and alarm are possible at the time of high-level radiation exposure, and a real-time shock detection function using change in gravity axis of the motion sensor is provided. The present invention provides specific means for comparing the cumulative radiation dose data and motion data with an activity history of a worker to improve work behavior of a worker.

### BRIEF DESCRIPTION OF THE DRAWINGS

FIG. 1 is a diagram illustrating a hardware configuration of a personal radiation dosimeter according to the present invention;

FIG. 2 is a diagram illustrating system configurations of a personal radiation dosimeter and a control server according to the present invention;

FIG. 3 is a diagram illustrating directionality of a 3-axis accelerometer;

FIG. 4 is a diagram illustrating a packet data type used in the present invention;

FIG. 5 is a diagram illustrating an example of a database according to the present invention;

FIG. 6 is a determination reference table of data used in the present invention;

FIG. 7 is a graph illustrating a database according to the present invention;

FIG. 8 is a graph illustrating an alert occurrence situation according to alert occurrence regulations; and

FIG. 9 is an algorithm for alert occurrence regulations according to a shock value and a radiation state.

### DETAILED DESCRIPTION OF THE PREFERRED EMBODIMENTS

Hereinafter, in order to describe the present invention in detail to the extent that those skilled in the art can easily carry out the present invention, the most preferred embodiment of the present invention will be described in detail with reference to the accompanying drawings.

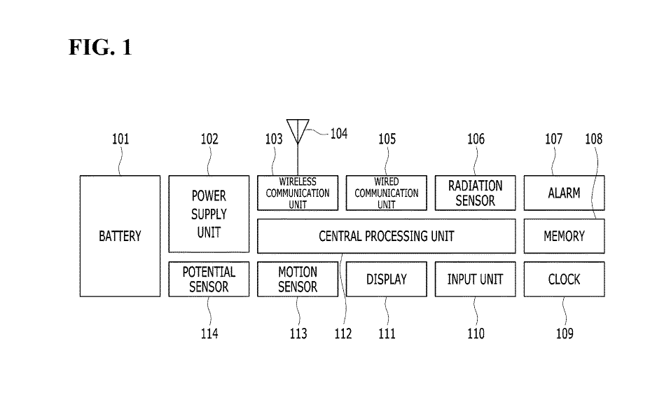

FIG. 1 is a block diagram illustrating a hardware of a wearable personal radiation dosimeter (WPRD) according to the present invention.

A radiation dose measurement device according to the present invention is referred to as a wearable personal radiation dosimeter (WPRD) for distinction from a thermo luminescent dosimeter (TLD) and a personal radiation dosimeter (PRD). The wearable personal radiation dosimeter (WPRD) is a small wearable personal radiation dosimeter which embodies all of merits of small size and low price of the conventional thermo luminescent dosimeter (TLD) and merits of real-time measurement, alarm, and communication function of the conventional personal radiation dosimeter (PRD).

Herein, a motion sensor which cannot be seen in the conventional dosimeters is attached to recognize movement of a worker. The hardware of the wearable personal radiation dosimeter (WPRD) is wearable, and uses a battery 101 as a power source. A power supply unit 102 which controls charge and discharge of the battery 101 is provided, and a potential sensor 114 which measures a battery level is provided to let a user know a charging moment. The conventional thermo luminescent dosimeter (TLD) does not need an electronic circuit, and thus does not need a central processing unit 112 or a power supply unit 102. However, the conventional personal radiation dosimeter (PRD) uses an electronic circuit, and thus the central processing unit 112 and the power supply unit 102 are essential. The central processing unit 112 takes charge of all controls and determinations of the wearable personal radiation dosimeter (WPRD), and a memory 108 is a device which stores measurement data and execution data. The memory 108 stores measurement data until the measurement data is transmitted to a control server 207 by using wired communication 103 or wireless communication 105. As the memory 108 gets larger, more data can be accumulated and stored.

A radiation sensor 106 is a device which measures a radiation dose as a key component of a radiation dosimeter. The radiation sensor 106 may be classified into GM counter, ionization chamber, semiconductor detector, scintillator, and the like according to the type of radiation measurement. Although any measurement-type sensor can be used as the radiation sensor 106 of the present invention, the scintillator-type radiation sensor is most preferable in comprehensive consideration of size, current consumption, measurement reliability, and the like. The radiation sensor 106 has to be able to measure 0.1 uSv/Hr or less, which is a natural radiation dose, and has to be able to measure various kinds of radiation and energy such as beta-ray, gamma-ray, X-ray, and neutron depending on usage. Particularly, the radiation sensor 106 has to be operated by a battery, and a characteristic of low current consumption is essential.

A motion sensor 113 is a sensor for recognizing movement by using a principle of FIG. 3 and Math 1, and is a core device of the present invention. As the motion sensor 113, a 3-axis accelerometer is most widely used, and the present invention is described on the basis of the principle of the 3-axis accelerometer. However, movement can be extracted even by using a gyro sensor, a magnetic sensor, or the like, and the contents of the present invention are not changed. Generally, the motion sensor 113 is manufactured as a semiconductor by using microelectromechanical systems (MEMS) nanotechnology, and consumes current like an electronic circuit. The motion sensor 113 does not consume large current to the extent of being operated by a battery, but steadily consumes current of several mA for acceleration sensing.

A clock 109 is necessary to know an accurate measurement time. Sensor data processed in the wearable personal radiation dosimeter (WPRD) are three kinds of potential, radiation dose, and motion, and meaningful behavior analysis is possible only when an accurate measurement time of the data is known. Accordingly, a clock 109 having characteristics of a real-time block generator has to be used. An input unit 110 is a device for user inputs such as user setting, alarm-off, and display operation, and may be a button switch or the like. A display 111 is a device which outputs various kinds of information for user convenience such as output of a measurement result, output of various kinds of messages, and confirmation of an operation state, and may be a display 111 having an advanced function such as an LCD. However, a simple display 111 such as an LED may be more suitable in consideration of restrictions of wearable type, low power, and the like. An alarm 107 is a device which generates an alarm for announcing an emergency situation such as high-level radiation exposure and falling-down of a worker. The alarm 107 may generate an alarm in forms of sound, light, vibration, and the like.

A wireless communication unit 103 is a wireless communication device for transmitting various kinds of data of the wearable personal radiation dosimeter (WPRD) to a control server 207, and a terminal such as a smartphone 202 or a note pad 203 provided outside. Wireless communication technology may be short-range wireless communication technology such as IEEE 802.15.1 Bluetooth communication technology, IEEE 802.15.4 ZigBee communication technology, and IEEE 802.11 Wi-Fi, lower power wide area network (LPWAN) technology such as SigFox and LoRa, or wireless communication technology using ISM bands of 400 MHz, 800 MHz, and 900 MHz. In addition, mobile communication (cellular network) technology such as 3G/4G may be used. An antenna 104 is a device which radiates a transmission and reception RF signal of the wireless communication unit 103 into the air. The wearable personal radiation dosimeter (WPRD) has wearable characteristics, and it is practical to design the antenna to an intenna. The wireless communication unit 103 and the antenna 104 may have an influence on a radiation measurement result of the radiation sensor 106 due to interference based on RF wireless signals. Accordingly, the wireless communication unit 103 and the radiation sensor 106 have to be designed such that a mutual interference phenomenon does not occur by thoroughly separating them in circuit. The wired communication unit 105 is a device for transmitting and receiving data to and from the outside by using wired communication such as USB, Serial, and Ethernet. Considering characteristics of the wearable personal radiation dosimeter (WPRD), it is general that the wireless communication unit 103 is a primary communication channel, and the wired communication unit 105 is a secondary communication channel.

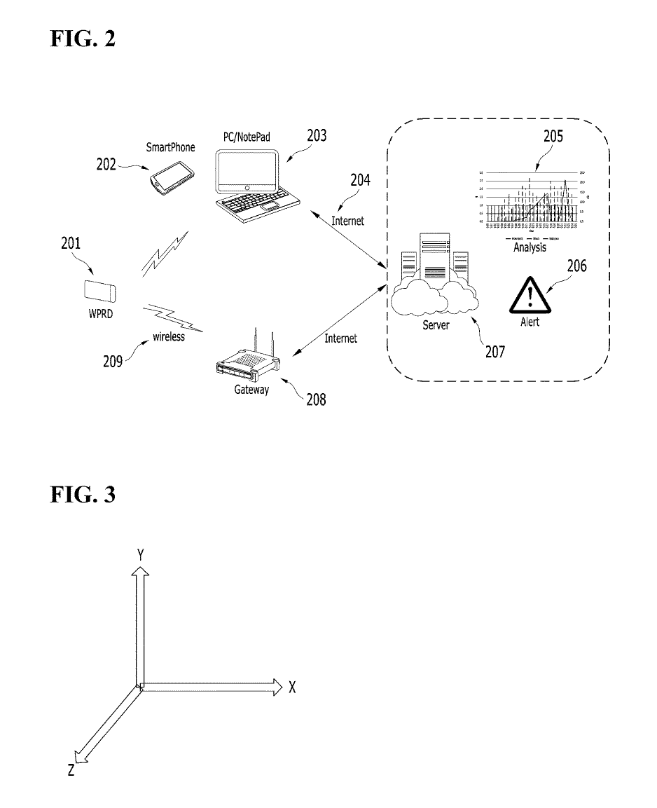

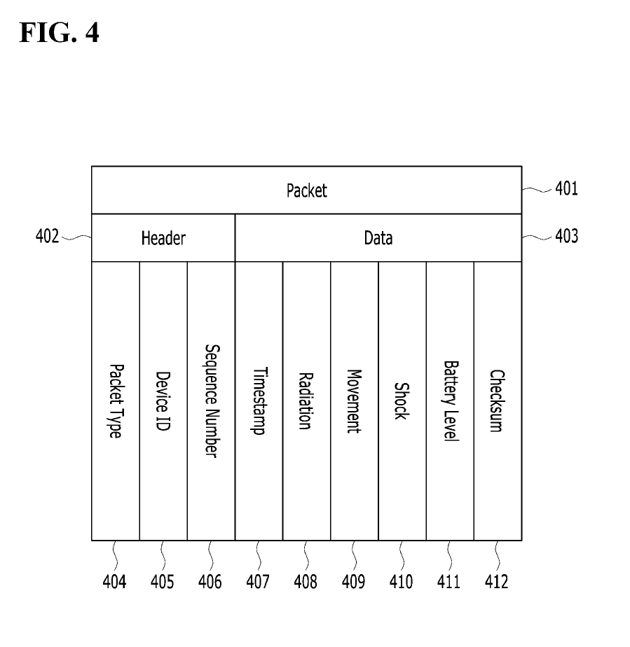

FIG. 2 illustrates a control system using the wearable personal radiation dosimeter (WPRD). A process of transmitting a packet message illustrated in FIG. 4 such as radiation dose and movement from the wearable personal radiation dosimeter (WPRD) 201 described in FIG. 1 to the control server 207 will be described. The packet message is transmitted from the wearable personal radiation dosimeter (WPRD) 201 to a gateway 208 by using a wireless signal 209 generated by the wireless communication unit 103, and the gateway 208 transmits the packet message to the control server 207 through an internet 204. The wearable personal radiation dosimeter (WPRD) 201 uses short-range wireless communication technology due to problems of current consumption, costs, and the like. Accordingly, in order to transmit data to the control server 207, the packet message has to pass through the gateway 208 having a broadband communication function. Meanwhile, the wearable personal radiation dosimeter (WPRD) 201 may directly transmit data by directly communicating with a terminal such as a smartphone 202, a PC, or a note pad 203 around a work site without passing through the control server 207, and may perform simple statistics or warning work. For example, a patient or a medical staff in a treatment room during radiation therapy in a hospital wears the wearable personal radiation dosimeter (WPRD) 201, radiation exposure data of many people are simultaneously collected in a treatment site, and a radiation exposure status is monitored in real time on the screen of the note pad 203 installed on the wall of the treatment room. Even in such a case, the terminal such as the smartphone 202 or the note pad 203 transmits data to the control server 207 such that the entire database has to be concentrated in the server. The control server 207 processes control processes such as analysis 205 of the collected data of the wearable personal radiation dosimeter (WPRD) 201, and generation of alert 206. The data of the control server 207 may be used to construct a radiation database of the unit of a wider range by interlocking with another management server, such as by region, country, and business group.

FIG. 3 illustrates directionality of a 3-axis accelerometer. The accelerometer uses acceleration of gravity g as the unit. X and Z detect horizontal acceleration, and are 0 g in a case of a stop state or a constant velocity state without acceleration. When acceleration occurs in an X-axis direction, a positive value is generated. When acceleration occurs in a direction opposite to the X-axis direction, a negative value is generated. Acceleration characteristics of a Z-axis direction are the same as those of the X-axis direction. Acceleration of a Y-axis direction has a value of 1 g in the stop state, and this is because acceleration of gravity always acts in the Y-axis. When acceleration occurs in the Y-axis direction, that is, rising up, a value larger than 1 is generated. When acceleration occurs in a direction opposite to the Y-axis direction, that is, falling down, a value less than 1 is generated. In the present invention, it is assumed that the wearable personal radiation dosimeter (WPRD) 201 is designed to maintain Y-axis directionality of the accelerometer. In other words, it is designed such that the Y axis is maintained although the X axis and the Z axis of the accelerometer may be changed. The designing to maintain directionality means designing to naturally maintain the Y axis even when the wearable personal radiation dosimeter (WPRD) 201 is worn on a body of a radiation worker. The reason why the Y axis is maintained is that shock operation detection to be described later is absolutely affected by the Y axis. In case of such a design in which it is impossible to maintain directionality, it is possible to input a direction through an initialization process. In other words, in a step of allowing a worker to wear the wearable personal radiation dosimeter (WPRD) 201 and operating it for the first time, it is moved in a designated direction such as up, down, forward, and backward along a predetermined scenario while seeing a sensor value in response thereto, thereby knowing X, Y, and X axes.

Movement in the 3-axis accelerometer means a change value of each of X, Y, and Z axes. It is represented by Math 1.

$${\sum }_{t = 0}^{59} \sqrt{{x}^{2} + {( y - 1 )}^{2} + {z}^{2}} \qquad [ Math 1 ]$$

Subtracting 1 only from the Y axis (y−1) is to correct a phenomenon that acceleration of gravy of 1 g always acts in the Y axis as described above. Summing from t=0to 59 is a process for conversion into movement of the unit of minute by summing motion sensor values detected by the unit of second for 60 seconds because a message is defined such that various kinds of sensor extraction units of the wearable personal radiation dosimeter (WPRD) 201 are the unit of minute. If the basic time unit is changed, the cumulative time of movement, radiation dose, and the like have to be changed together according thereto. The reason why the value of each axis is squared and added as illustrated in Math 1 is to obtain only a movement change value in disregard of movement directionality. In application separately requiring a change value for each axis, only the value of each axis may be separately extracted and used.

Shock in the 3-axis accelerometer means a change value of the Y axis. It is represented by Math 2.

\sqrt{y²} [Math 2]

As seen here, only the Y axis is used for shock detection. There is no adding process to convert a sensor change value from the unit of second into the unit of minute. Since shock temporarily occurs for a short time of 1 second or less in the Y axis, it is designed in consideration of such characteristics of shock. However, differently from other data applied by the unit of minute, a system designer has to keep in mind that a shock value has to be applied by the unit of second. As described above, since the momentary up and down movement change value of the Y axis is a shock value, the appearance of the wearable personal radiation dosimeter (WPRD) 201 has to be designed such that the Y axis is directed up and down. The reason why the Y axis is set to the shock value is that the Y-axis value is rapidly changed in case of fainting or falling down due to shock when movement characteristics of a radiation worker is analyzed. If other movement characteristics of a worker are interpreted as shock, the other value suitable there has to be used.

FIG. 4 illustrates a data type used in the present invention. Packet data 401 transmitted from the wearable personal radiation dosimeter (WPRD) 201 to the server 207 may include a header 402 presenting an attribute portion of the message, and data 403 presenting a content portion of the message. The header 402 includes a packet type 404, a device serial number (device ID) 405, and a sequence number 406. The packet type 404 represents attributes of the message promised in advance such as whether the packet is a command or data. In the present invention, it is assumed that only one kind of data attribute is used for convenience of description. The device serial number 405 is a unique identification number of the wearable personal radiation dosimeter (WPRD) 201, and represents a unique number assigned to each device so as not to overlap. The sequence number 406 represents a transmission order of the packet 401. The transmission order of the packet transmitted for the first time from the wearable personal radiation dosimeter (WPRD) 201 is 1, and the transmission order of the packet transmitted for the next time is 2. As described above, the sequence number 406 is a sequentially increasing value, normally has a 16-bit (65536) range, and is used to determine overlap or omission of messages. The packet data 403 is actual data to be processed in the control server 207 such as various sensor values provided in the wearable personal radiation dosimeter (WPRD) 201, and includes a timestamp 407, a radiation dose (radiation) 408, a movement value (movement) 409, a shock value (shock) 410, a battery level 411, and a checksum 412. The timestamp 407 represents a time when data is detected by various sensors of the wearable personal radiation dosimeter (WPRD) 201, and is set by the unit of minute in the present invention. In order to secure an accurate time, the clock 109 provided in the hardware is used. The radiation dose 408 is a value obtained by converting a radiation dose per minute detected by the radiation sensor 106 into the unit of uSv. The movement value 409 is a value obtained by converting the change values of X, Y, and Z detected by the motion sensor 113 as represented in Math 1. The shock value 410 is a value obtained by converting the change value of Y detected by the motion sensor 113 as represented in Math 2. The battery level 411 is a potential value of the battery 101 detected by the potential sensor 114. The checksum 412 is a value used to check whether the entire data of the packet 401 is transmitted without an error, and a value obtained by summing the entire data of the packet 401 is mainly used.

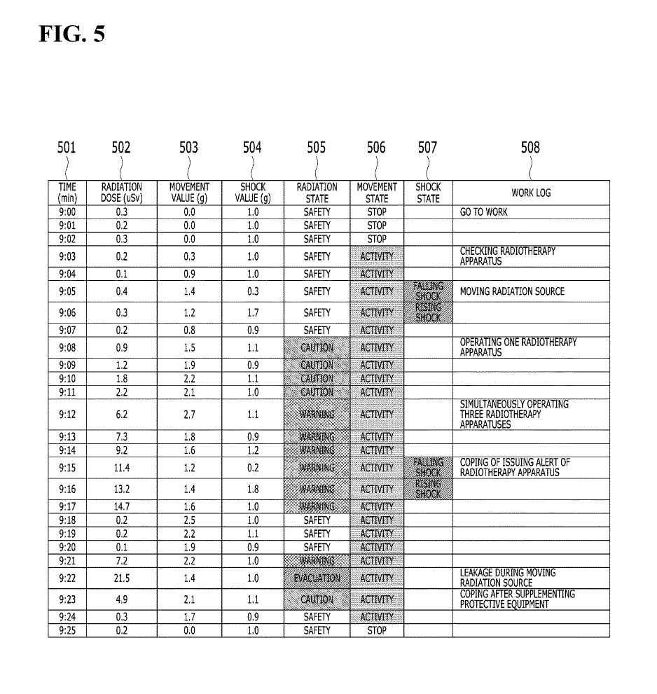

FIG. 5 is a diagram illustrating an example of arranged data 403 in the packet 401 illustrated in FIG. 4 received by the management server 207. The time 501 represents the timestamp 407 by the unit of minute. In the example, it is described to start from AM 9:00 without date information, but the real database should include date information together. The radiation dose 502 is stored by the unit of uSv, and it is normal to process up to 1 decimal place. The movement value 503 and the shock value 504 are detection results of the motion sensor 113, the unit thereof is acceleration of gravity g, and they are processed up to 1 decimal place. As described above, the time 501, the radiation dose 502, the movement value 503, and the shock value 504 are data 403 field detected by the wearable personal radiation dosimeter (WPRD) 201, and later radiation state 505, movement state 506, shock state 507, work log 508, and the like are process data field analyzed and determined by the server.

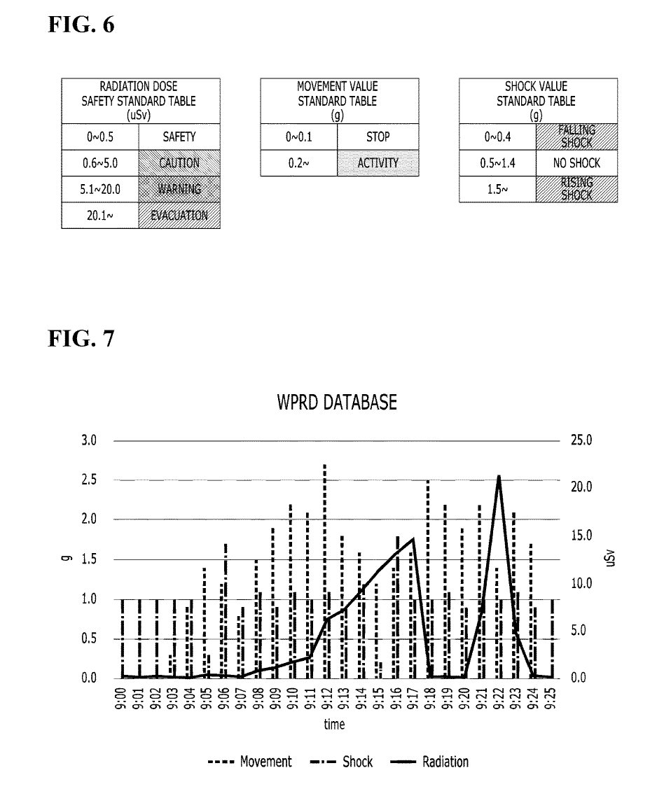

The process data field can be extracted from a reference table illustrated in FIG. 6. In a radiation dose safety reference table (uSv), 0 to 0.5 uSv is a natural radiation level, which is considered as being safe. 0.6 to 5.0 uSv is an caution-needed level because radiation may reach a personal annual radiation exposure limit in case of continuous exposure. 5.1 to 20.0 uSv is a warning-needed level because it may be dangerous in case of continuous exposure for one hour or more. 20.1 uSv is an immediate-evacuation-needed level because it may be dangerous even in case of exposure for a moment. Such radiation dose safety reference values may be changed and set in accordance with radiation working environment and radiation dose safety standard. In the movement value reference table, when the movement value in FIG. 5 is 0.1 g or less, the movement value is classified into stop, and when the movement value is 0.2 or more, it is classified into activity. The activity value of 0.2 g or more is for distinguishing only an activity state without detailed distinction. If it is necessary to distinguish detailed activity such as less activity and much activity in accordance with radiation work environment, it is possible to further subdivide activity. In the shock value reference table, a change value is detected on the basis of 1 g, which is acceleration of gravity in a natural system. Since 0.0 g is detected in case of natural fall, 0.4 g or less may be determined as falling shock. In other words, a value of 0.4 g or less is shock occurrence based on falling, and it may be inferred as a worker suddenly falling down. A value of 1.5 g or more is shock based on rising, and it may be inferred as a worker suddenly getting up. Although a worker slowly gets up, it is possible to obtain the same value as sudden getting up by accumulating the values in accordance with characteristics of the motion sensor 113. Accordingly, when such rising shock occurs, it may be determined that the worker gets up. The range of 0.5 to 1.4 g is determined as up and down movement of posture in accordance with natural activity, and may be determined as no shock.

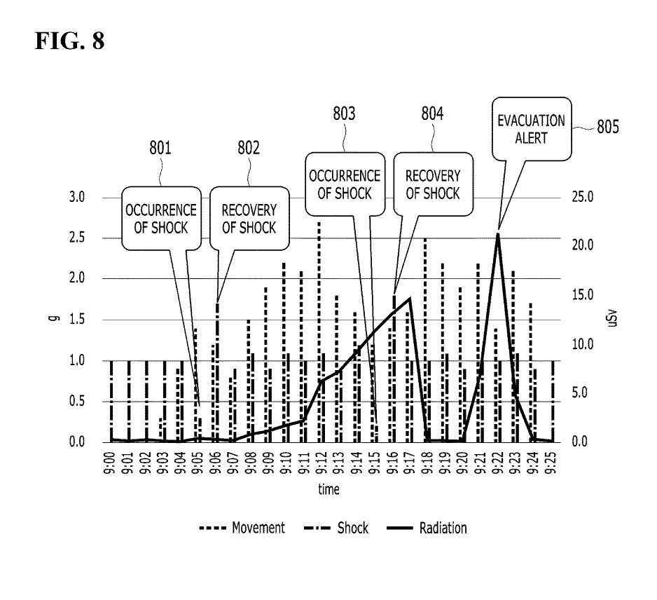

FIG. 7 illustrates a graph of the values illustrated in FIG. 5, to show the movement value and the radiation dose to be further visually and easily understood. It can be easily known that the shock values are distributed in the vicinity of 1 g, which is acceleration of gravity, and it can be visually and easily known that the detection range of the radiation dose is 0.1 to 21.5 uSv and the radiation doses are widely distributed 200 times or more. It is represented that the movement value does not exceed 3.0 g, and it can be known that a change value is not so large when an actual worker does not radically move. Practically, probability that an artificial radiation dose different from a natural radiation dose by thousands of times to hundreds of thousands of times is to be momentarily generated is sufficient. Accordingly, it can be known that the radiation dose is distributed in a very wide range to the extent that it is difficult to express the radiation dose by a graph.

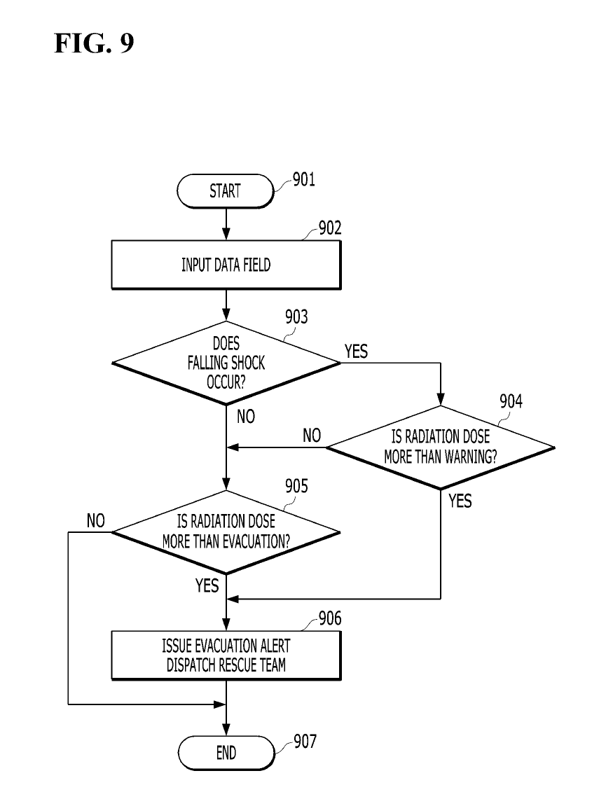

It is possible to set determination criteria of an analysis program 205 and a warning program 206 of the control server 207 on the basis of various kinds of sensor data extracted in the wearable personal radiation dosimeter (WPRD) 201 illustrated in FIG. 5. The radiation state 505 is determined on the basis of the radiation dose 502, and the movement state 506 is determined on the basis of the movement value 503, and the shock state 507 on the basis of the shock value 504. The work log 508 is for grasping the detailed work unit on the basis of a work log of a radiation worker, and is received through handwork or a separate device. When interpreting the database illustrated in FIG. 5 by time zone, it can be known that a worker went to work at 9:00 and rested up to 9:02. It can be known that the worker started activities to check a radiotherapy apparatus at 9:03, and did normal activities in a safe radiation state up to 9:04. Falling shock 507 occurred in the course of moving a radiation source at 9:05. However, since the radiation state 505 was a safe state, an alert was not issued in accordance with alert occurrence regulations illustrated in FIG. 9. Since rising shock 506 was detected at 9:06, it can be confirmed that the worker recovered the posture and continued with the normal activities. In such a case, an accident did not occur for the worker during moving the radiation source, but the worker fell down. Accordingly, it is possible to make the worker to know that the worker should pay more attention and calmly move. It shows that it is possible to achieve the object of increase in safety through improvement of activity behavior of a radiation worker as one of the effects of the present invention. It can be known that one radiotherapy apparatus was operated at 9:08, and the radiation state 505 was upgraded to a caution step. However, the worker continued with the normal activities up to 9:11, and thus any action was not necessary. Total three apparatuses were simultaneously operated by additionally operating two radiotherapy apparatuses at 9:12, and the radiation state 505 was raised to a warning level. The radiation state 505 was high as the warning level up to 9:14, but the overall movement state 506 was kept as normal, and falling shock 507 occurred at 9:15. It means that the radiation worker fell down in the radiation state 505 of the warning level. An alert was issued in accordance with the alert occurrence regulations illustrated in FIG. 9, and a rescue team was dispatched. Since rising shock 507 occurred at 9:16 and the movement state 506 was kept as activity, it can be known that the radiation worker was rescued or recovered and was in normal activities. Even in such a case, a shock cause of the worker is analyzed afterwards and is reported to the worker, and a work manual is improved to prevent the same warning from occurring later. The radiation state 505 represented the normal movement state 506 in the safe level from 9:18, the radiation state 505 was raised to the warning level at 9:21, and the radiation state 505 was rapidly raised to the evacuation level at 9:22. In that case, an immediate evacuation alert is issued in accordance with the alert occurrence regulations illustrated in FIG. 9, and a rescue team is dispatched. Such an accident is determined as an accident of radiation leakage during moving a radiation source according to the work log 508. Also in this case, a detailed work manual for movement of a radiation source is improved to prevent the same accident from occurring later. It can be known that the accident measures were finished at 9:23, and the radiation state 505 is returned to the caution level, and then was returned to the normal state at 9:24. It can be known that the radiation worker was in a state without movement and shock in the stable radiation state 505, that is, a rest state at 9:25. As described above, when simultaneously using the radiation sensor 106 and the motion sensor 113 provided in the wearable personal radiation dosimeter (WPRD) 201, it is possible to more precisely acquire and utilize information about activities and safety of the radiation worker.

FIG. 9 is an algorithm for the alert occurrence regulations according to the shock value 504 and the radiation state 505. The start 901 occurs every time 501, that is, every minute. Data 403 based on FIG. 4 is input 902, and it is determined whether falling shock occurs 903 on the basis of the shock value 504. When the falling shock occurs, it is determined whether the radiation dose is more than warning 904. When the radiation dose is more than warning, an evacuation alert is issued and a rescue team is dispatched 906. When the radiation dose is less than warning 904 or the falling shock does not occur 903, it is determined whether the radiation dose is more than an evacuation level 905. When the radiation dose is more than the evacuation level, an evacuation alert is issued and a rescue team is dispatched 906. As described above, the alert occurrence regulations have to be generated by appropriately combining the shock value and the radiation dose in accordance with the radiation work environment, and such regulations may be variously set in accordance with work place and work environment.

FIG. 8 illustrates an alert occurrence situation according to the shock value 504 and the radiation state 505 in graph through the example illustrated in FIG. 5. Falling shock 507 occurred at 9:05 (801), but the radiation state 505 was a safe state, and an alert was not issued. Falling shock 507 occurred at 9:15 (803) and the radiation state 505 was the warning level, thus an alert was issued since it matched with the alert occurrence regulations. Since the radiations state 505 was detected as the evacuation level regardless of the shock state 507 at 9:22, an alert was issued in accordance with the alert occurrence regulations illustrated in FIG. 9.

Whether a radiation worker wears a wearable personal radiation dosimeter (WPRD) 201, a wearing time, and the cumulative radiation dose at the time of wearing can be extracted from the database illustrated in FIG. 5. The wearable personal radiation dosimeter (WPRD) 201 is assigned to a specific radiation worker and is used to record the cumulative radiation dose, and may be regulated such that other cannot use it. In such a case, the cumulative radiation dose of the radiation worker may be recorded to measure and manage individual exposure limit. In addition, it is possible to check whether the radiation worker normally wears the wearable personal radiation dosimeter (WPRD) 201 and works, and to know a wearing time, thus it is possible to catch any behavior out of regulations such as working without wearing the dosimeter or wearing the other person's dosimeter.

Herein, the total cumulative radiation dose is represented by Math 3.

Total cumulative radiation dose=Stop cumulative radiation dose+Activity cumulative radiation dose

=(Temporary stop cumulative radiation dose+Long-time stop cumulative radiation dose)+activity cumulative radiation dose [Math 3]

In other words, as represented in Math 3, the total cumulative radiation dose is acquired by summing the stop cumulative radiation dose and the activity cumulative radiation dose, and the stop cumulative radiation dose is the sum of the temporary stop cumulative radiation dose and the long-time stop cumulative radiation dose. Herein, various cases capable of determining whether the personal radiation dosimeter is lawfully worn can be estimated. First, when the activity cumulative time is significantly shorter than that of a personal work log, it is possible to estimate the fact that the radiation worker worked without wearing the dosimeter, which is a violation of regulations. Second, when there is no work in the work log and the activity cumulative time is detected, it is possible to estimate the fact that the other worker wore the dosimeter and worked, which is a violation of regulations. Third, when the long-time stop cumulative radiation dose is excessively higher than that of the other worker, it is estimated that a space for storing the dosimeter or a rest space of workers is excessively exposed to radiation, and thus it is determined that safety measures for this is needed. Fourth, when the temporary stop cumulative radiation dose is excessively higher than that of the other worker, it means that a rest time of the worker for a while is long in the high-level radiation environment. Accordingly, it is necessary to train the worker to improve the work behavior to quickly finish the work, and be out of the high-level radiation environment. Fifth, when the total cumulative radiation dose is excessively higher than that of the other worker, the cause thereof should be understood to improve the work environment or to move the work to non-radiation environment, and thus to manage the radiation dose not to be over the annual allowable exposure value. As described above, when the movement value and the radiation dose are recorded and compared simultaneously, it is possible to understand various kinds of work environments and activities of the radiation worker, and thus it is possible to contribute to safety of the radiation worker.

What is claimed is:

1. A data processing method of a personal radiation dosimeter, comprising steps of:
detecting a value of a radiation sensor provided with a dosimeter;
generating a movement value by a motion sensor value provided in the dosimeter;
generating a shock value which is a change value of a gravity axis from the motion sensor value provided in the dosimeter;
generating a measurement time in a clock sensor provided in the dosimeter;
coupling data values of the sensors into one-packet data;
transmitting the packet data to a control server through a communication device; and
extracting a motion state of a dosimeter wearer in radiation work environment on the basis of the radiation sensor value and motion sensor value of the packet data.

2. The data processing method according to claim 1, wherein the motion sensor is a 3-axis accelerometer.

3. The data processing method according to claim 1, further comprising a step of issuing an alert when falling shock occurs in a high-level radioactive status on the basis of the shock value and the radiation sensor value.

4. The data processing method according to claim 1, further comprising a step of comparing an activity time with a stop time to determine whether a dosimeter is worn.

5. The data processing method according to claim 1, further comprising a step of determining a case where the movement value is an activity state at the time without a work history of a worker and the radiation sensor value is equal to or more than a reference value, as use by others.

6. The data processing method according to claim 1, wherein the communication device uses any one of ZigBee communication, Bluetooth communication, Wi-Fi communication, and low power wide area network (LPWAN).
